(19) United States
(12) Patent Application Publication
(10) Pub. No.: US 2024/0228335 A1
(43) Pub. Date: Jul. 11, 2024

(54) Architecture For High Throughput Plasma Based Water Treatment

(71) Applicant: THE REGENTS OF THE UNIVERSITY OF MICHIGAN, Ann Arbor, MI (US)

(72) Inventors: Roxanne WALKER, Ann Arbor, MI (US); Joseph Groele, Ann Arbor, MI (US); Terese Olson, Ann Arbor, MI (US); John E. Foster, Ann Arbor, MI (US)

(21) Appl. No.: 18/404,551

(22) Filed: Jan. 4, 2024

Related U.S. Application Data
(60) Provisional application No. 63/437,771, filed on Jan. 9, 2023.

(51) Int. Cl. C02F 1/46

(52) U.S. Cl. CPC C02F 1/4608; C02F 2201/002; C02F 2201/4614; C02F 2209/40; C02F 2209/44; C02F 2301/024

(57) ABSTRACT

A system and method for processing a fluid to be treated. The flow reactor system having a detention tank having an influent and an effluent. The detention tank receiving the fluid to be treated from the influent and outputting a treated fluid from the effluent. The flow reactor system having a recirculation system fluidly coupled to the detention tank and configured to circulate a recirculation fluid from the detention tank to the detention tank. The recirculation system having a first line fluidly coupled to the detention tank, a second line downstream of the first line fluidly coupled to the detention tank, a recirculation pump fluidly coupled between the first line and the second line and providing a fluid driving force, and a plasma reactor operably coupled to the second line to treat the recirculation fluid to achieve a contact time sufficient to process the fluid to be treated and output the treated fluid.

### CROSS-REFERENCE TO RELATED APPLICATIONS

This application claims the benefit of U.S. Provisional Application No. 63/437,771, filed on Jan. 9, 2023. The entire disclosure of the above applications is incorporated herein by reference.

### GOVERNMENT INTEREST

This invention was made with government support under 1747739 awarded by the National Science Foundation. The government has certain rights in the invention.

### FIELD

The present disclosure relates to water treatment and, more particularly, relates to an architecture for high throughput plasma-based water treatment.

### BACKGROUND & SUMMARY

This section provides background information related to the present disclosure which is not necessarily prior art. This section provides a general summary of the disclosure, and is not a comprehensive disclosure of its full scope or all of its features.

Conventionally, plasma water treatment reactors employ a batch mode technique. The present teachings convert from batch mode explored in previous systems, as disclosed in commonly-assigned U.S. Pat. No. 10,662,086 which is incorporated herein by reference, to a flow reactor geometry while preserving batch mode kinetics. In some embodiments, thorough the use of a series of reactors with recirculation such that water exposure to plasma matches the contact time in a batch reactor, the present teachings can achieve similar degradation in a flow through geometry.

In some embodiments, the present teachings provide a system and method for processing a fluid to be treated. The flow reactor system having a detention tank having an influent and an effluent. The detention tank receiving the fluid to be treated from the influent and outputting a treated fluid from the effluent. The flow reactor system having a recirculation system fluidly coupled to the detention tank and configured to circulate a recirculation fluid from the detention tank to the detention tank. The recirculation system having a first line fluidly coupled to the detention tank, a second line downstream of the first line fluidly coupled to the detention tank, a recirculation pump fluidly coupled between the first line and the second line and providing a fluid driving force, and a plasma reactor operably coupled to the second line to treat the recirculation fluid to achieve a contact time sufficient to process the fluid to be treated and output the treated fluid.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a system having a plurality of plasma reactors arranged in series according to some embodiments of the present teachings.

FIG. 1B illustrates a system having a continuous flow process including a recirculation system according to some embodiments of the present teachings.

FIG. 2 illustrates a schematic diagram of a continuous flow plasma treatment process with a membrane concentration stage according to some embodiments of the present teachings.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Per and Poly fluorinated alkyl substances (PFAS), whose origins date to the 1940s, are a class of compounds possessing high thermal and chemical stability. The compounds have been used in a range of consumer products owing to these robust properties. Owing to their unusual stability and thus long half-life, these compounds have proliferated in the environment. It is now well established that ingestion of these chemicals can lead to the development of a range of health disorders from endocrine disruption to cancer. Regulations at the federal and state level are setting health advisories of maximum acceptable concentration level. Unfortunately, conventional water treatment systems cannot remove PFAS. The recalcitrant nature of these compounds owing to the strength and shielding effects of the carbon fluorine bond makes destructive removal difficult (typical bond energies ˜100 kcal/mol). Membrane and activated carbon are capable of removing PFAS effectively, but each creates a concentrated waste stream. The US EPA identifies a research gap low-cost method to process concentrate streams from membrane processes or cheaper method to regenerate activated carbon.

PFAS removal via plasma treatment is predominantly a surface treatment process—essentially long chain hydrophobic PFAS compounds are degraded by energetic electrons, ions, and UV light exposure. Considerable destruction is initiated via reduction by solvated electrons derived from the plasma where electron addition leads to spontaneous bond cleavage and defluorination. To destroy the PFAS with plasma, multiple exposures of the fluid surface is required to reduce the contaminants to smaller chains and ultimately to mineralization.

The present teachings further provide systems and methods that utilize plasma to destroy PFAS compounds in concentrate streams derived from membrane processes. While it is widely recognized that plasmas are effective at destroying PFAS, it is desired to scale up the processing and quantify overall implementation and operational cost. To date, plasma reactors—even large-scale ones—have been predominantly batch-mode reactors. It is desirable in industrial or municipal applications to treat water in a flow reactor configuration, thereby providing enhanced throughput for high demand applications. The present teachings demonstrate a once-through, scalable flow plasma reactor capable of treating practical influent flows according to principles of the present invention. The end goal is the realization of a fieldable architecture for destructive removal of PFAS.

In some embodiments, the present teachings provide systems and methods for plasma-based flow reactor geometry while preserving batch mode kinetics. In some embodiments, the present teachings provide a scalable 10 gallons per minute (gpm) flow system with capacity up to 50 gpm.

### Reactors-In-Series Embodiment

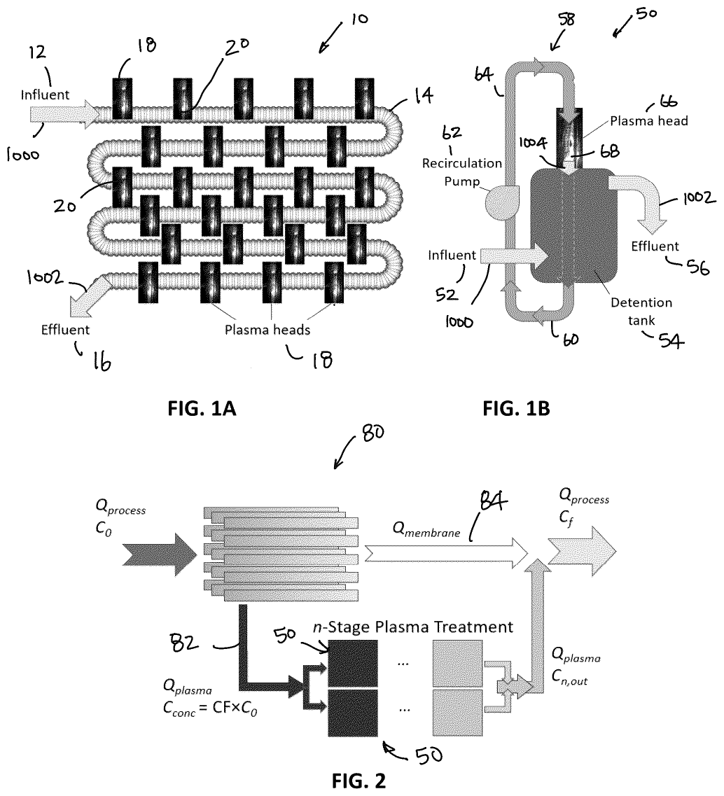

Broadly, according to the present teachings, batch treatment processing is converted and/or adapted to provide continuous flow treatment processing for the purpose of significantly scaling up the volume of water to be treated using plasma treatment. In some embodiments, as illustrated in FIG. 1A, a continuous flow reactor system 10 having an influent 12 for receiving a fluid to be treated 1000, containing PFAS, for example, and a line 14 delivering a treated fluid 1002 having reduced and/or eliminated PFAS to an effluent 16. The line 14 is a continuous line having a singular pathway. Continuous flow reactor 10 further comprises a plurality of plasma heads or reactors 18 disposed in spaced and/or distributed relationship along line 14 for exposing fluid within the pathway of line 14 to plasma produced by each of the plurality of plasma heads 18. For this type of continuous flow system, the water passes by each plasma head 18 only once, thus many plasma heads 18 in series are required to achieve sufficient plasma exposure. In other words, a reaction and associated decomposition occurs at each of the plurality of localized reaction zones 20 where the plasma discharge is in contact with the fluid and, in combination, the plurality of localized reaction zones 20 deliver the proper dose of reactive species to the fluid. In this way, the present teachings provide continuous flow treatment of the water to remove PFAS and output treated fluid from effluent 16. In some embodiments, this can be considered series flow and the fluid is exposed to plasma treatment as a sum total of each of the plurality of localized reaction zones 20 (i.e., reactors-in-series). However, a plurality of series-flow lines can be disposed in parallel for additional capacity throughput. Each of the plurality of localized reaction zones 20 contributes to the plasma exposure (i.e., plasma-water contact area and contact time) of the fluid.

However, it should be understood that in some applications, the system of FIG. 1A can become prohibitively large and complex, particularly when scaling-up to higher flow rates, as a plurality of flow lines in parallel each containing a multitude of plasma reactors 18 would be required to realize local treatment conditions faithful to that of a batch reactor.

### Recirculation Embodiment

In some embodiments, as illustrated in FIG. 1B, a system and method are provided to achieve the required treatment dose by recirculating water multiple times through a plasma “active zone” of a micro-reactor with rapid recirculation fitted to a well-sized detention tank. That is, in some embodiments, a recirculation flow reactor system 50 is provided having an influent 52 for receiving a fluid to be treated 1000, containing PFAS, for example, a detention tank 54 configured to contain fluid and an effluent 56 for outputting treated fluid 1002 having reduced and/or eliminated PFAS. A recirculation system 58 is provided to recirculate fluid within detention tank 54 through a treatment loop.

In some embodiments, recirculation system 58 comprises a first line 60 fluidly coupled between detention tank 54 and a recirculation pump 62. Recirculation pump 62 is configured to pump and/or transfer fluid (i.e., a recirculation fluid 1004) from detention tank 54 through first line 60 and recirculation pump 62 to a second line 64 downstream of first line 60. Second line 64 is fluidly coupled to detention tank 54 and includes a plasma reactor 66 disposed in line therewith. In this way, recirculation fluid 1004 transferred via first line 60, recirculation pump 62, and second line 64 is treated with plasma reactor 66 as the fluid is passed thereby at a plasma zone 68. Recirculation fluid treated by plasma reactor 66 is returned to detention tank 54, thereby mixing with fluid already contained therein. It should be noted that in some embodiments, first line 60 and second line 64 are separate from influent 52 and effluent 56.

In operation, fluid to be treated 1000 enters detention tank 54 sized to have a characteristic hydraulic retention time (HRT)—that is, the average amount of time required for a molecule of water or any other liquid to pass through a bioreactor or a tank, allowing enough time to accomplish the removal of a specific pollutant, usually a ratio of the volume to the inlet flowrate. Fluid to be treated 1000 entering influent 52 is rapidly cycled through recirculation system 58, including plasma reactor 66, as a recirculation fluid so that the number of passes per unit time matches that utilized in traditional batch reactor processing. After recirculation fluid is reintroduced into detention tank 54 and mixes with existing fluid therein, the treated fluid 1002 is output from effluent 56.

According to the present teachings, a range of contaminants can be treated in this manner with those requiring more direct plasma treatment being processed in plasma zone 68 during multiple recirculation cycles, and whereas remaining contaminants are treated in the detention tank zone 70 contained within detention tank 54 by being exposed to longer-lived reactive species residing in detention tank 54. In some embodiments, recirculation system 58 is configured to operate intermittently, continuously, and/or on-demand to promote sufficient processing of fluid within detention tank 54 prior to outflow from effluent 56. It should also be understood that a flowrate of recirculation system 58 can be varied, set, and/or modulated to achieve a sufficient plasma exposure for processing. That is, a flowrate of recirculation system 58 can be increased to provide additional plasma exposure and/or to provide additional longer-lived reactive species within detention tank 54 to continued processing.

It should be appreciated that the present embodiment provides a number of advantages over conventional systems. For example, the present embodiment is configured to provide similar plasma exposure (i.e., plasma-water contact area and contact time) with a substantially more compact system. Moreover, the present embodiments can be configured with a single or reduced number of plasma reactors 66, thereby reducing cost, size, and complexity.

The performance of the present recirculation embodiment can be estimated using a tanks-in-series model applied to a reactive system. Mass balances for n number of tanks in series yield the following expression for a first-order reaction:

$$\frac{{C}_{n , out}}{{C}_{0}} = \frac{1}{{( 1 + k τ )}^{n}} \qquad ( 1 )$$

Where C₀ is the initial contaminant concentration entering a series of n reactors, C_{n,out} is the contaminant concentration at the outlet of the series of reactors, k is the first-order decay constant, and τ is the hydraulic retention time at each plasma stage. Equation (1) can be rearranged to solve for the value of kτ required to achieve a desired C_{n,out} for a given C₀ and n.

$$k τ = \sqrt[n]{\frac{{C}_{0}}{{C}_{n , out}} - 1} \qquad ( 2 )$$

If a concentration stage 80 (see FIG. 2) is employed prior to the plasma treatment, then C₀ is replaced by C_{conc}=C₀×CF, where CF is the concentration factor achieved by the concentration stage, and C_{conc} is the concentration of concentrate/reject stream of the membrane concentration stage. In some embodiments, concentration stage 80 can comprise an absorption system and method of removing PFAS to produce a higher concentration waste fluid stream to be treated by the plasma. In some embodiments, concentration stage 80 can comprise a membrane (shown) or activated carbon, a foam fractionation, and/or a reverse osmosis system. In some embodiments where a reverse osmosis system is employed, an output liquid can comprise a purified water stream and a highly concentrated PFAS-laden stream, which is treated by the plasma. In some embodiments, concentration stage 80 can output both a high concentration waste stream 82 and a low concentration stream 84. In this way, concentration stage 80 could be a reverse osmosis stage which generates both a high concentration stream (concentrate) which is treated by the plasma stage, and a low concentration stream (permeate) or purified water. A schematic diagram of a continuous flow staged plasma treatment process with a membrane concentration stage is provided in FIG. 2. More particularly, FIG. 2 illustrates a process according to some embodiments of the present teaching in which the PFAS is first concentrated via concentration stage 80, and the concentrated PFAS effluent 82 is treated in a number (n) of recirculating plasma reactors 50. In some embodiments, each box in the “n-stage plasma treatment” represents recirculation flow reactor system 50 such that the effluent of the first stage becomes the influent of the second stage, and so on. Additionally, it should be noted that the recirculation flow reactor systems 50 of FIG. 2 are illustrated in series with dots therebetween to indicate n reactors in series. Moreover, FIG. 2 illustrates two (or more) parallel legs of reactors in series.

### Role of Turbulence in Improving the Plasma-Fluid Contact Surface Area

Plasma-based water purification or fluid decontamination involves the transport of reactive species across the gas liquid interface. Plasma treatment of water is limited by slow diffusion driven mass transport of reactive species across the interface. Additionally, the plasma gas-liquid contact area is typically limited and also contributes to reduced dose delivery. These key factors make it difficult to scale up conventional treatment processes to input flows of industrial interest.

In some embodiments, turbulence can be used in accordance with the present teachings. In particular, in some embodiments, turbulence can be introduced into the fluid stream passing through the plasma reaction zones 20, 68. It should be understood that turbulent flow may be introduced in a number of way, such as but not limited to increasing the mean velocity of fluid while maintaining the physical geometry of the pipe (hydraulic diameter) to increase the Reynolds number above the threshold to transition from laminar to turbulent flow, introduce physical structures (i.e., turbulators) to the lines and/or heads, or other variations to encourage and/or produce non-laminar flow. It has been found that the introduction of turbulent flow improves reactive species transport to the fluid due to enhanced surface area, contact, and mixing, and therefore provides an additional term and capability to the recirculation treatment stage. In other words, when recirculation is applied, the necessary amount of recirculation relative to a multi-head plasma configuration may decrease due to the transition from a laminar flow regime to a turbulent flow regime. The turbulence transports contaminants in the bulk fluid to the interface where it can be more directly treated by plasma. The use of turbulence greatly enhances the capability of the reactor to treat hydrophilic species, such as short chain PFAS compounds.

It should be understood that the principles of the present teachings find utility with a wide range of plasma applications and systems. While it is recognized that certain plasma applicator methods are more effective than others at treating certain classes of contaminants, one can envision the use of this methodology with multiple plasma source types for a holistic treatment of wastewater, removing both the simple and the previously recalcitrant.

It should also be understood that the principles of the present teachings are not limited to plasma treatment for n-Stage sections. These principles are equally application to any type of treatment in which locally dosed water with treatment input (i.e., energy or chemicals). Additionally, it should be appreciated that membrane treatment can be replaced with any concentration stage (i.e., foam fractionation).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A flow reactor system for processing a fluid to be treated, the flow reactor system comprising:
a detention tank having an influent and an effluent, the detention tank receiving the fluid to be treated from the influent and outputting a treated fluid from the effluent;
a recirculation system fluidly coupled to the detention tank and configured to circulate a recirculation fluid from the detention tank to the detention tank, the recirculation system having a first line fluidly coupled to the detention tank, a second line downstream of the first line fluidly coupled to the detention tank, a recirculation pump fluidly coupled between the first line and the second line and providing a fluid driving force, and a plasma reactor operably coupled to the second line to treat the recirculation fluid to achieve a contact time sufficient to process the fluid to be treated to a predetermined treatment quality and output the treated fluid.

2. The flow reactor system according to claim 1 wherein the detention tank is sized to attain a predetermined hydraulic retention time.

3. The flow reactor system according to claim 2 wherein the detention tank is size to achieve once-through treatment of the fluid to be treated to

4. The flow reactor system according to claim 1 wherein the plasma reactor treats the recirculation fluid at a reaction zone.

5. The flow reactor system according to claim 1 further comprising a turbulence system configured to introduce turbulent flow of the recirculation fluid.

6. The flow reactor system according to claim 1 wherein the turbulence system is configured to produce a flowrate of the recirculation fluid sufficient to produce turbulent flow.

7. The flow reactor system according to claim 1 further comprising a concentration stage having an absorption system configured to receive a fluid and output a concentrated waste fluid stream to be treated by the plasma, the concentrated waste fluid stream having a higher concentration of a predetermined matter compared to the received fluid.
